(19) United States
(12) Patent Application Publication
(10) Pub. No.: US 2007/0139337 A1
(43) Pub. Date: Jun. 21, 2007

(54) DISPLAY PANEL DRIVING DEVICE FOR REDUCING CROSSTALK AND DRIVING METHOD THEREOF

(76) Inventors: Liang-Hua Yeh, Taipei County (TW); Jiao-Lin Huang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,167

(22) Filed: Dec. 19, 2005

(51) Int. Cl. G09G 3/36

(52) U.S. Cl. 345/96

(57) ABSTRACT

A display panel driving device capable of reducing crosstalk and a driving method thereof is disclosed. The display panel driving device includes a plurality of source driving units, a NOT gate and a timing controller. The timing controller, through the NOT gate, provides an inversed-polarity control signal for the source driving units. The display panel driving method includes providing a polarity control signal produced by a timing controller for the remaining source driving units, then inverting the polarity and providing the other partial source driving units with the inversed-polarity control signal. The driving device and the driving method enable the polarities of the pixels on a same horizontal scanning line to be neutral to the greatest extent and avoid crosstalk caused by coupling effect between data lines and the common voltage Vcom. Consequently, the present invention significantly improves the display quality of a display panel by reducing crosstalk.

### BACKGROUND OF THE INVENTION

1. Field of Invention

The present invention relates to a display panel driving device and a driving method thereof, and particularly to a display panel driving device capable of reducing crosstalk and a driving method thereof.

2. Description of the Related Art

To improve a display quality of a display panel, the polarity of the signal driving the display panel is often inverted. For example, an AC driving mode, instead of a DC driving mode, is preferred to avoid liquid crystal from polarization in a TFT-LCD where liquid crystal is employed as display material. Accordingly, various driving methods capable of inverting polarization are developed, such as line inversion, dot inversion and column inversion.

FIG. 1 is a diagram showing the driving structure of a general LCD display. Referring to FIG. 1, a source driver 110 and a gate driver 120 output a plurality of pixel driving signals and a plurality of scanning signals to the corresponding data lines and scanning lines in the display panel 130, respectively. In general, the source driver 110 is formed by a plurality of source driving ICs, while the gate driver 120 is formed by a plurality of gate driving ICs. A plurality of pixel units of the display panel 130, such as the pixel unit 140, is electrically connected to the corresponding data lines and scanning lines. Each pixel unit stores pixel driving signals of data lines according to a scanning signal sequence, respectively.

FIG. 2 is a diagram of two adjacent pixel units to explain how a horizontal crosstalk is produced. Referring to FIG. 2, in all pixel units on a same scanning line (for example, a scanning line 210), such as pixel units 231 and 232, the switches 241 and 242 are simultaneously turned on as a scanning signal arrives. Meanwhile, all pixel units on the scanning line 210 would store the pixel driving signals of the corresponding data lines, such as data lines 221 and 222, into the storage capacitors Cₛₜ and the liquid crystal capacitors C_{lc} in the pixel units, respectively. Note that the rotation angle of liquid crystal molecule in a pixel unit depends on the voltage level difference between both ends of the liquid crystal capacitor C_{lc} thereof. Further note that parasitic capacitors Csc are always present between each data line and a common voltage line, so that the signal waveform of the common voltage Vcom in the common voltage line is affected by all data line signals. When the common voltage Vcom is affected by coupling effects from all data lines and the Vcom voltage level is slightly changed, the voltage differences C_{lc} in liquid crystal capacitors generated by storing pixel driving signals are not completely expected voltage differences and therefore an unexpected gray level of the pixel unit appears. The phenomenon is called horizontal crosstalk.

It is assumed that the display panel 130 is a ‘normal white’-type one, i.e. as no voltage is applied to a liquid crystal capacitor, the optical transmittance thereof is the highest. FIG. 3A is a schematic relationship curve of optical transmittance vs. voltage produced by a ‘normal white’-type display panel. Wherein, in the high and low portion of the liquid crystal voltage, the variation of the liquid crystal voltage has a little effect on black and white luminousness. On the other hand, in the middle portion of the liquid crystal voltage, the variation of the liquid crystal voltage exerts a tremendous influence to the medium gray level. Therefore, at the time of level in studying horizontal crosstalk, we make discussion for the change of medium gray level. FIG. 3B is a diagram showing different positive/negative voltage levels corresponding to ‘white’ gray level with a positive voltage +W or a negative voltage −W, ‘black’ gray level with a positive voltage +B or a negative voltage −B and medium gray level with a positive voltage +M or a negative voltage −M, respectively.

Take a dot inversion as an example. FIG. 4A is a diagram showing a partial pixel unit matrix of a conventional display panel in dot inversion mode. Referring to FIG. 4A, as all pixel units on the scanning line SLI are turned on, the pixel driving signals are sent to the turned-on pixel units by the data lines DL1˜DL12. In the dot inversion mode, the pixel units with any odd number of the scanning line SL1 take a medium gray level with a positive voltage +M, while the pixel units with any even number of the scanning line SL1 take a medium gray level with a negative voltage −M. Similarly, as all pixel units on the scanning line SL2 are turned on, the pixel driving signals are sent to the turned-on pixel units by the data lines DL1˜DL12.

FIG. 4B is a timing diagram of the common voltage signal Vcom in the display panel in FIG. 4A. When the pixel units of the scanning lines SL1, SL2, SL5 and SL6 are driven, since the coupling energy between the positive voltage +M of medium gray level and the common voltage Vcom and the coupling energy between the negative voltage −M of medium gray level and the common voltage Vcom can offset, they have little effect on the signal of the common voltage Vcom. Onto the scanning lines SL3 and SL4, even though the data lines DL5˜DL8 of the central block deliver ‘black’ pixel driving signals with a higher voltage, the coupling energy between the positive voltage +B and the common voltage Vcom and the coupling energy between the negative voltage −B and the common voltage Vcom can offset, so they have also little effect on the signal of the common voltage Vcom.

FIG. 5A is a conventional diagram showing a partial pixel unit matrix of a display panel in dot inversion mode. Wherein, a frame with a ‘Cs open’ background color accompanying a central black block is displaced. The ‘Cs open’ background color means the pixel units with any odd number display ‘medium gray level’, while the pixel units with any even number display ‘black level’. As all pixel units on the scanning lines SL1˜SL6 are sequentially turned on, the pixel driving signals are sent to the turned-on pixel units by the data lines DL1˜DL12. Thus, the pixel units with any odd number of the odd scanning lines take a medium gray level with a positive voltage +M, while the pixel units with any even number of the odd scanning lines take ‘black’ with negative voltage −B; the pixel units with any odd number of the even scanning lines take a medium gray level with a negative voltage −M, while the pixel units with any even number of the even scanning lines take a ‘black’ with positive voltage +B; wherein, the pixel units of the central black block take a ‘black’ with positive voltage +B and a ‘black’ with negative voltage −B.

FIG. 5B is a waveform sequence of the common voltage signal Vcom in the display panel in FIG. 5A. When the pixel units of the scanning lines SL1 and SL5 are driven, since the coupling energy between the positive voltage +M of medium gray level and the common voltage Vcom is far less than the coupling energy between the negative voltage −B of ‘black’ and the common voltage Vcom, the signal of the common voltage Vcom would be affected by the data lines DL1˜DL12, generating negative impulses. When the pixel units of the scanning lines SL2 and SL6 are driven, since the coupling energy between the negative voltage −M of medium gray level and the common voltage Vcom is far less than the coupling energy between the positive voltage +B of ‘black’ and the common voltage Vcom, the signal of the common voltage Vcom would be affected by the data lines DL1˜DL12, generating positive impulses. For the scanning lines SL3 and SL4 however, where the positive voltage +B and the negative voltage −B of the central ‘black’ block can offset, when the pixel units of the scanning lines SL3 or SL4 are driven, only smaller negative impulses or smaller positive impulses are present with the common voltage Vcom. The wider the central black block is, the larger the pulse voltage difference ΔVp is (i.e. a larger brightness difference), which makes more serious crosstalk.

FIG. 6A is a diagram showing a conventional partial pixel unit matrix of a display panel in dot inversion mode, where a frame with a ‘medium gray level’ background color accompanying a central ‘Cs open’ block is displayed. As all pixel units on the scanning lines SL1˜SL6 are sequentially turned on, the pixel driving signals are sent to the turned-on pixel units by the data lines DL1˜DL18. FIG. 6B is a waveform sequence of the common voltage signal Vcom in the display panel in FIG. 6A. When the pixel units of the scanning lines SL1, SL2, SL5 and SL6 are driven, since the coupling energy between the positive voltage +M of medium gray level and the common voltage Vcom and the coupling energy between the negative voltage −M of medium gray level and the common voltage Vcom can offset, they have little effect on the signal of the common voltage Vcom. For the central ‘Cs open’ block, the pixel units with any odd number of the scanning line SL3 take a medium gray level with a positive voltage +M, while the pixel units with any even number of the scanning line SL3 take a negative voltage −B of ‘black’. Since the coupling energy between the positive voltage +M of the medium gray level and the common voltage Vcom is far less than the coupling energy between the negative voltage −B of ‘black’ and the common voltage Vcom, when the pixel units of the scanning lines SL3 are driven, the signal of the common voltage Vcom would be affected by the data lines DL1˜DL18, generating larger negative impulses. On the other hand, for the central ‘Cs open’ block, the pixel units with any odd number of the scanning line SL4 take a medium gray level with a negative voltage −M, while the pixel units with any even number of the scanning line SL4 take a positive voltage +B of ‘black’. Since the coupling energy between the negative voltage −M of the medium gray level and the common voltage Vcom is far less than the coupling energy between the positive voltage +B of ‘black’ and the common voltage Vcom, when the pixel units of the scanning lines SL4 are driven, the signal of the common voltage Vcom would be affected by the data lines DL1˜DL12, causing larger positive impulses. The wider the central ‘Cs open’ block, the larger the pulse voltage difference AVp is (i.e. larger brightness difference), which makes more serious crosstalk.

It can be learned that crosstalk would seriously affect the display quality of a display panel. The solution to avoid crosstalk is highly desired.

### SUMMARY OF THE INVENTION

An object of the present invention is to provide a display panel driving device capable of reducing crosstalk. Wherein, a timing controller provides each source driving unit with different polarity control signal by means of a NOT gate to make the polarity of a same horizontal scanning line neutral to the greatest extent, so that the coupling between data lines with different polarities of the display panel and the common voltage Vcom is reduced to the minimum and the crosstalk is accordingly avoided.

Another object of the present invention is to provide a display panel driving method capable of reducing crosstalk. Wherein, by changing the polarity signals received at the polarity ends of the source driving units, the polarity of a same horizontal scanning line is neutral to the greatest extent, so that the coupling between data lines with different polarities of the display panel and the common voltage Vcom is reduced to the minimum and the crosstalk is accordingly avoided.

Based on the above described and other objects, the present invention provides a display panel driving device capable of reducing crosstalk. The driving device includes a plurality of source driving ICs, a NOT gate and a timing controller. All the source driving ICs share a polarity end and according to the polarity of the shared end decide and output pixel driving signals. To run the device, first, the timing controller outputs a plurality of pixel data to each source driving ICs and outputs a polarity control signal to the input end of the NOT gate. The input end of the NOT gate is electrical connected to the polarity ends of the partial source driving ICs, while the output end thereof is electrical connected to the polarity ends of the other partial source driving ICs. Then, the source driving ICs according to the polarity of the shared end decide the polarity of the pixel driving signals to be output. Finally, the source driving ICs convert the received corresponding pixel data into pixel driving signals for output.

On the other hand, the present invention provides a display panel driving device capable of reducing crosstalk. The driving device includes a plurality of source driving units, a NOT gate and a timing controller. All the source driving units share a polarity end and according to the polarity of the shared end decide and output pixel driving signals. To run the device, first, the timing controller outputs a plurality of pixel data to each source driving units and outputs a polarity control signal to the input end of the NOT gate. The input end of the NOT gate is electrical connected to polarity ends of the partial source driving units, while the output end thereof is electrical connected to the polarity ends of the other partial source driving units. Then, the source driving units, according to the polarity of the shared end, decide the polarity of the pixel driving signals to be output. Finally, the source driving units convert the received corresponding pixel data into pixel driving signals for output.

The present invention further provides a display panel driving method capable of reducing crosstalk. The method includes the following steps. First, a polarity control signal is provided to the polarity ends of the partial source driving units. Next, the polarity control signal is inversed to obtain an inversed-polarity control signal, which is sent to the polarity ends of the other partial source driving units. Further, each source driving unit, according to the polarity end thereof, decides the pixel driving signal to be output. Finally, each of the source driving units outputs a pixel driving signal to drive the display panel.

The novel scheme of the present invention herein is to alter the polarity control signals for each source driving unit. In this way, the polarities of pixels located on a same horizontal scanning line of a display panel are almost neutral to the greatest extent, which avoids coupling on the common voltage Vcom, thereby reducing crosstalk caused by the coupling and significantly improving display quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a diagram showing the driving structure of a general LCD display.

FIG. 2 is a diagram of two adjacent pixel units to explain how a horizontal crosstalk is produced.

FIG. 3A is a schematic relationship curve of optical transmittance vs. voltage produced by a ‘normal white’-type display panel.

FIG. 3B is a diagram showing different positive/negative voltage levels corresponding to ‘white’, ‘black’ and medium gray level, respectively.

FIG. 4A is a diagram showing a partial pixel unit matrix of a conventional display panel in dot inversion mode.

FIG. 4B is a waveform sequence of the common voltage signal Vcom in the display panel in FIG. 4A.

FIG. 5A is a diagram showing a partial pixel unit matrix of a display panel in dot inversion mode, which is conventionally tested by a frame with a ‘Cs open’ background color accompanying a central black block.

FIG. 5B is a waveform sequence of the common voltage signal Vcom in the display panel in FIG. 5A.

FIG. 6A is a diagram showing a partial pixel unit matrix of a display panel in dot inversion mode, which is conventionally tested by a frame with a ‘medium gray level’ background color accompanying a central ‘Cs open’ block.

FIG. 6B is a waveform sequence of the common voltage signal Vcom in the display panel in FIG. 6A.

FIG. 7A is a circuit block diagram of a LCD display panel driving device according to the first embodiment of the present invention.

FIG. 7B is a diagram showing a partial pixel unit matrix of the display panel in dot inversion mode of the first embodiment, wherein a frame with a ‘Cs open’ background color accompanying a central black block is used for testing.

FIG. 7C is a diagram showing a partial pixel unit matrix of the display panel in dot inversion mode of the first embodiment, wherein a frame with a ‘medium gray level’ background color accompanying a central ‘Cs open’ block is used for testing.

FIG. 8A is a circuit block diagram of a LCD display panel driving device according to the second embodiment of the present invention.

FIG. 8B is a diagram showing a partial pixel unit matrix of the display panel in dot inversion mode of the second embodiment, wherein a frame with a ‘Cs open’ background color accompanying a central black block is used for testing.

FIG. 8C is a diagram showing a partial pixel unit matrix of the display panel in dot inversion mode of the second embodiment, wherein a frame with a ‘medium gray level’ background color accompanying a central ‘Cs open’ block is used for testing.

FIG. 9 is a circuit block diagram of a LCD display panel driving device according to the third embodiment of the present invention.

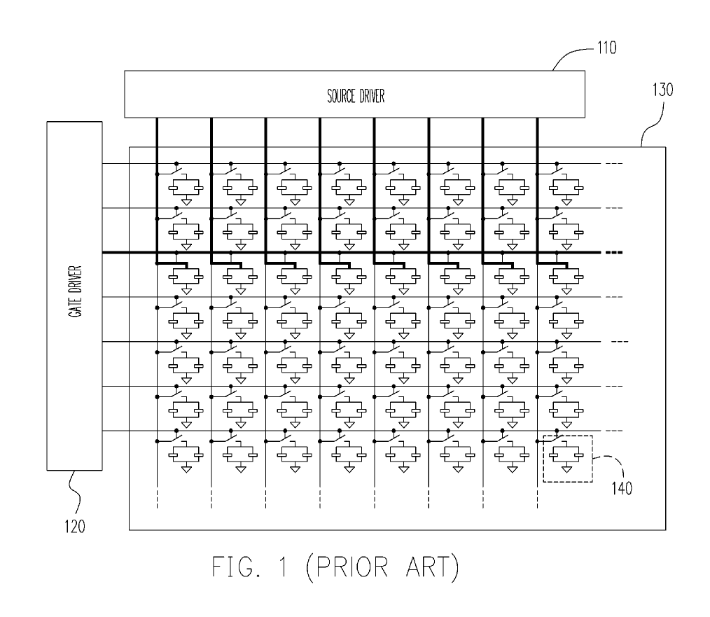

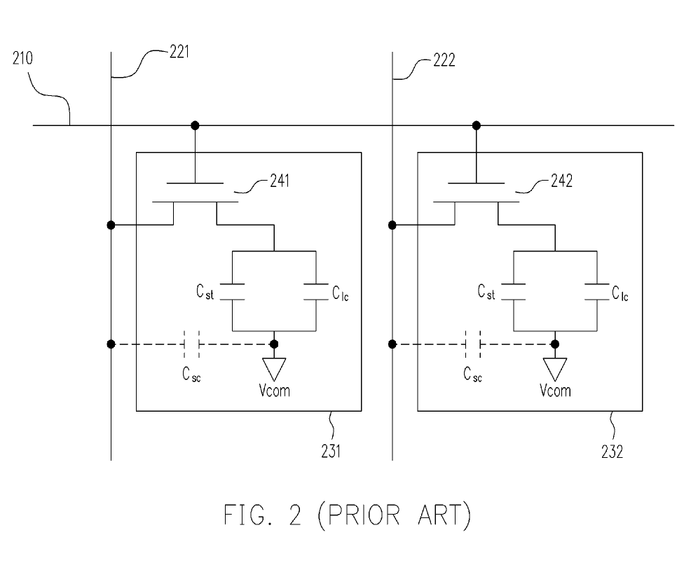

### DESCRIPTION OF THE EMBODIMENTS

For simplicity, all following embodiments take a LCD display panel as an example, but it doesn't limit the application scope of the present invention. In fact, anyone skilled in the art can easily apply the present invention to other types of display panels without departing from the scope or spirit of the invention.

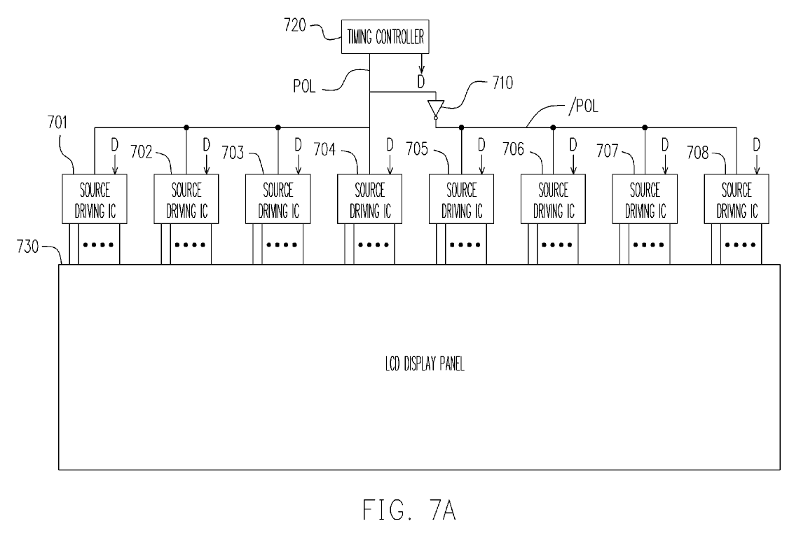

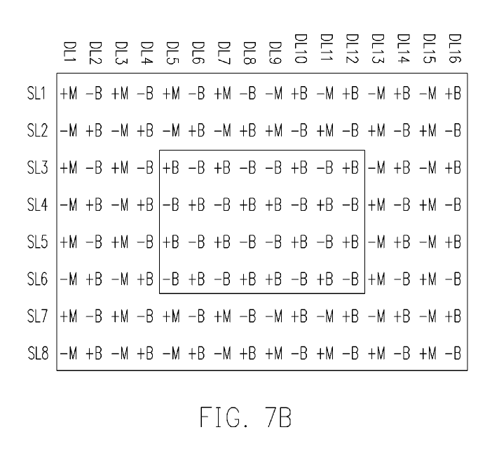

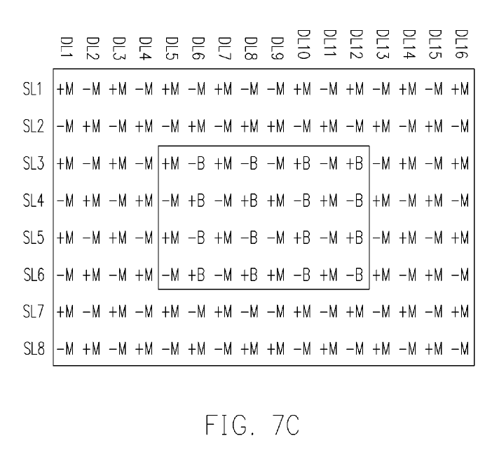

FIG. 7A is a circuit block diagram of a LCD display panel driving device capable of reducing crosstalk according to the first embodiment of the present invention. Referring to FIG. 7A, the display panel driving device includes a plurality of source driving ICs 701˜708, a NOT gate 710, a timing controller 720 and a LCD display panel 730. The timing controller 720 sequentially delivers a plurality of pixel data to the source driving ICs 701˜708. The timing controller 720 also outputs a polarity control signal POL, and each source driving IC according to the received polarity control signal POL decides the polarity of the pixel driving signal to be output.

In the embodiment, the timing controller 720 provides a polarity control signal POL to the polarity ends of the source driving ICs 701˜704 for the left half of the display panel 730; while the polarity ends of the source driving ICs 705˜708 for the right half of the display panel 730 receive the inverted polarity control signal POL, i.e. the inverting-polarity control signal/POL, from the NOT gate 710. All the pixel data received by the source driving ICs 701˜708 are converted into corresponding pixel driving signals and the polarities of the output pixel driving signals depend on the signals of the corresponding polarity ends thereof. The source driving ICs 701˜708 output a plurality of the pixel driving signals for driving the display panel 730. Although only eight source driving ICs are shown in FIG. 7A, the real number of the source driving ICs is not limited to eight and depends on the product requirement.

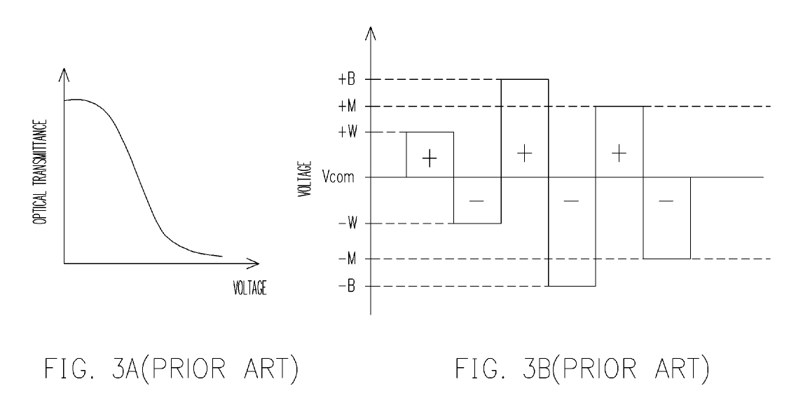

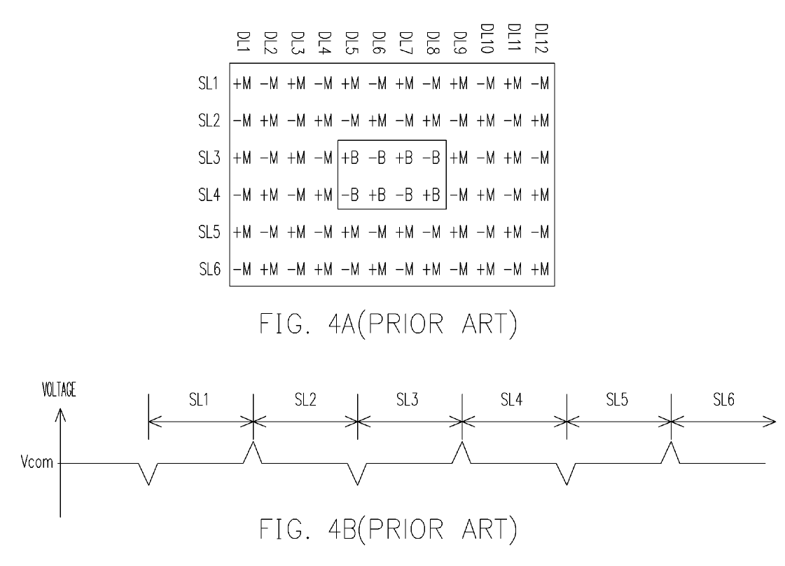

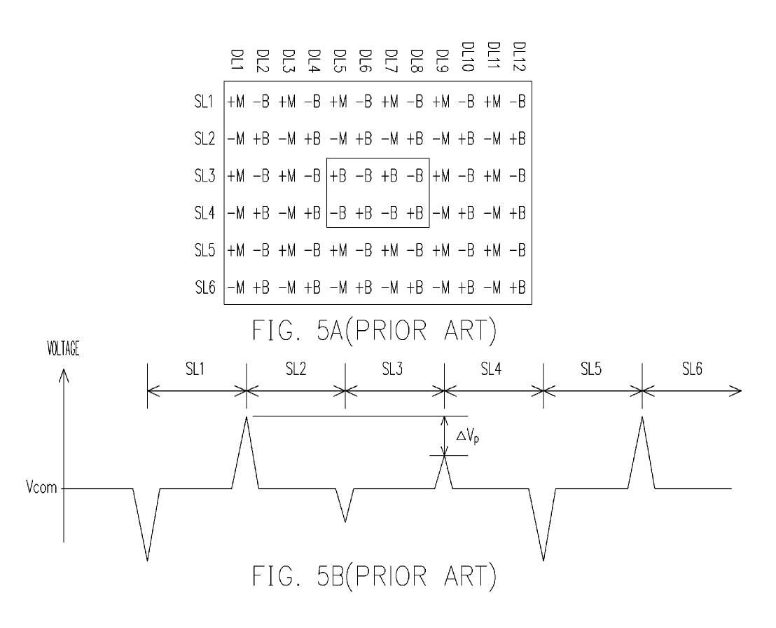

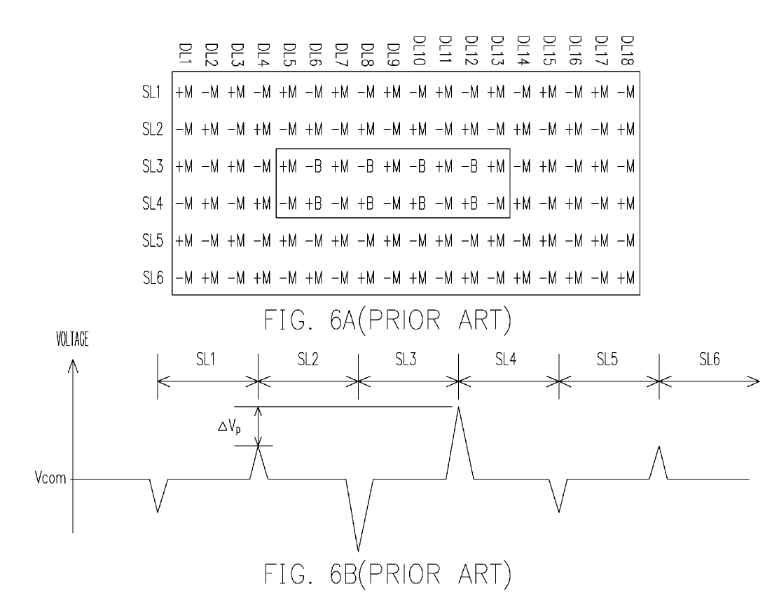

FIGS. 7B and 7C are diagrams showing a partial pixel unit matrix of the display panel 730 in dot inversion mode of the first embodiment. It is assumed the display panel 730 is a ‘normal white’-type display panel; that is, the optical transmittance thereof is the highest as the liquid capacitors are not applied by any voltage. FIG.3A shows the relationship curve of optical transmittance vs. voltage produced by a ‘normal white’-type display panel. +B and −B in FIG. 7B indicate a positive voltage and a negative voltage of ‘black’ gray level for driving the pixel unit, respectively; while +M and −M indicate a positive voltage and a negative voltage of medium gray level for driving the pixel unit, respectively.

In FIG. 7B, a frame with a ‘Cs open’ background color accompanying a central black block for a display panel in dot inversion mode is shown as an example. The ‘Cs open’ background color means the pixel units with any odd number display ‘medium gray level’, while the pixel units with any even number display ‘black level’. Referring to FIGS. 7A and 7B, when the pixel units of the scanning line SL1 are turned on, the source driving ICs 701˜708 deliver the pixel driving signals to the turned-on pixel units through the data lines DL1˜DL16. Since the dot inversion mode is used in the display panel, among the pixel units of the scanning line SL1, the data lines DL1, DL3, DL5 and DL7 feed a positive voltage +M of medium gray level to the corresponding pixel units, while the data lines DL2, DL4, DL6 and DL8 feed a negative voltage −B of ‘black’ gray level to the corresponding pixel units. As the above described, the NOT gate 710 converts the polarity control signal POL into an inversed-polarity control signal/POL output to the source driving ICs 705˜708. Therefore, among the pixel units of the scanning line SL1, the data lines DL9, DL11, DL13 and DL15 feed a negative voltage −M of medium gray level to the corresponding pixel units, while the data lines DL10, DL12, DL14 and DL16 feed a positive voltage +B of ‘black’ gray level to the corresponding pixel units. Similarly, as the pixel units of the scanning lines SL2˜SL8 are sequentially turned open, the data lines DL1˜DL16 would deliver the corresponding pixel driving signals from the source driving ICs to the turned-on pixel units, respectively.

It can be seen from the above described that, when sequentially turning on the pixel units of the scanning lines SL1˜SL8, each time the polarities of the pixel driving signals at a same gray level delivered by the data lines DL1˜DL16 are able to complement each other, hence the pixel polarities on a same horizontal scanning line of the display panel are neutral to the greatest extent, which can reduce the coupling on the common voltage Vcom to the minimum, thereby avoiding crosstalk caused by the coupling and significantly improving display quality.

FIG. 7C is a diagram of a partial pixel unit matrix of the display panel in dot inversion mode of the first embodiment, wherein a frame with a ‘medium gray level’ background color accompanying a central ‘Cs open’ block is shown. Referring to FIGS. 7A and 7C and taking the medium scanning line SL3 as an example, when the pixel units of the scanning line SL3 are turned on, the source driving ICs 701˜708 deliver the pixel driving signals to the turned-on pixel units through the data lines DL1˜DL16. Since the dot inversion mode is used in the display panel, among all pixel units of the scanning line SL3 for the left half of the display panel, the data lines DL1, DL3, DL5 and DL7 feed a positive voltage +M of medium gray level to the corresponding pixel units, while the data lines DL2 and DL4 feed a negative voltage −M of medium gray level to the corresponding pixel units and the data lines DL6 and DL8 feed a negative voltage −B of ‘black’ gray level to the rest corresponding pixel units. As the above described, the NOT gate 710 converts the polarity control signal POL into an inversed-polarity control signal/POL output to the source driving ICs 705˜708. Therefore, among all pixel units of the scanning line SL3 for the right half of the display panel, the data lines DL9, DL11, DL13 and DL15 feed a negative voltage −M of medium gray level to the corresponding pixel units, while the data lines DL10 and DL12 feed a positive voltage +B of ‘black’ gray level to the corresponding pixel units and the data lines DL14 and DL16 feed a positive voltage +M of medium gray level to the corresponding rest pixel units. Similarly, as the pixel units of the scanning lines SL4˜SL8 are sequentially turned open, the data lines DL1˜DL16 would deliver the corresponding pixel driving signals to the turned-on pixel units, respectively.

In other words, when sequentially turning on the pixel units of the scanning lines SL1˜SL8, each time the polarities of the pixel driving signals at a same gray level delivered by the data lines DL1˜DL16 are able to complement each other, hence the pixel polarities on a same horizontal scanning line of the display panel are neutral to the greatest extent, which can reduce the coupling between the common voltage Vcom and the data lines to the minimum, thereby avoiding crosstalk caused by the coupling and significantly improving display quality.

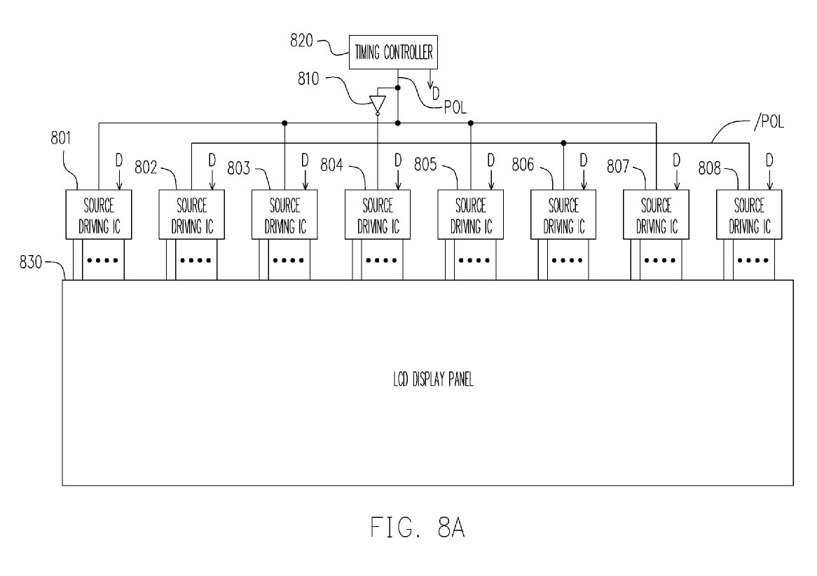

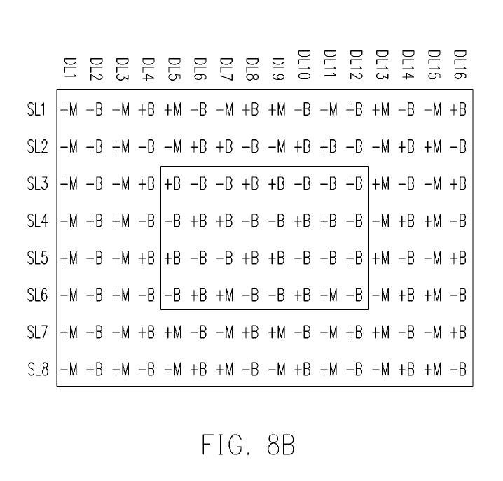

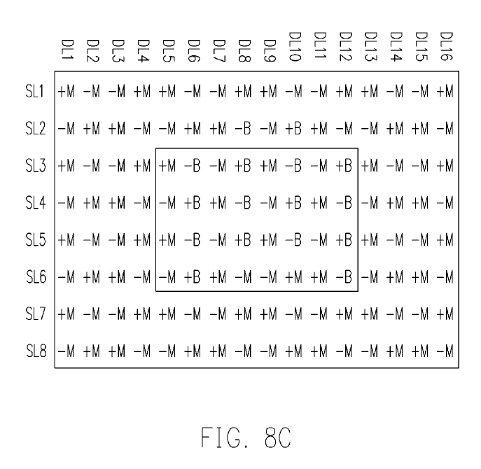

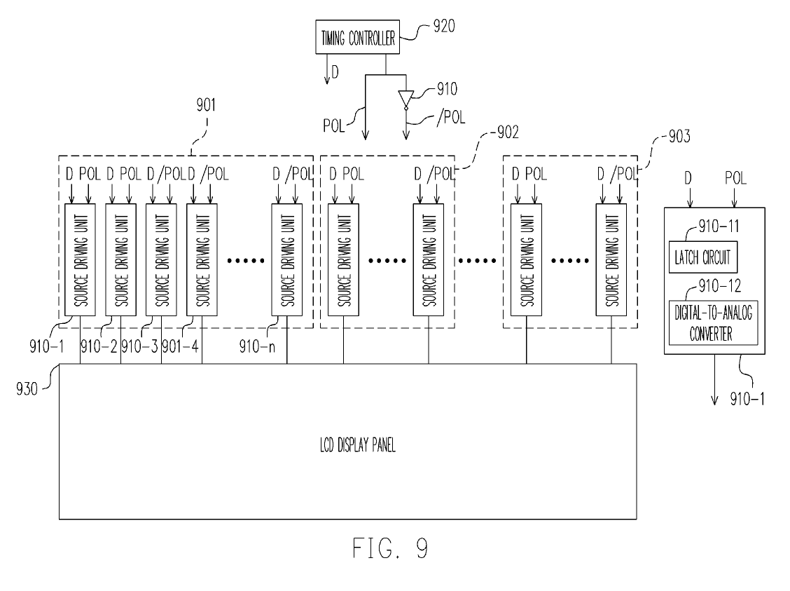

FIG. 8A is a circuit block diagram of a LCD display panel driving device capable of reducing crosstalk according to the second embodiment of the present invention. Referring to FIG. 8A, the display panel driving device includes a plurality of source driving ICs 801˜808, a NOT gate 810, a timing controller 820 and a LCD display panel 830. The source driving ICs 801˜808, the NOT gate 810, the timing controller 820 and the LCD display panel 830 in the embodiment are similar to the source driving ICs 701˜708, the NOT gate 710, the timing controller 720 and the LCD display panel 730 in the first embodiment except that the timing controller 820 provides a polarity control signal POL to the polarity ends of the source driving ICs with odd number, 801, 803, 805 and 807; while the inversed-polarity control signal/POL output from the NOT gate 810 is sent to the polarity ends of the source driving ICs with even number, 802, 804, 806 and 808. Although only eight source driving ICs are shown in FIG. 8A, the real number of the source driving ICs is not limited to eight and depends on the product requirement.

FIGS. 8B and 8C are diagrams showing a partial pixel unit matrix of the display panel 830 in dot inversion mode of the second embodiment. It is assumed the display panel 830 is a ‘normal white’-type display panel; that is, the optical transmittance thereof is the highest as the liquid capacitors are not applied by any voltage.

In FIG. 8B, a frame with a ‘Cs open’ background color accompanying a central black block for a display panel in dot inversion mode is shown as an example. Referring to FIGS. 8A and 8B, when the pixel units of the scanning line SL1 are turned on, the source driving ICs 801˜808 deliver the pixel driving signals to the turned-on pixel units through the data lines DL1˜DL16. Since the dot inversion mode is used in the display panel, among the pixel units of the scanning line SL1, through the data lines DL1, DL5, DL9 and DL13, the source driving ICs 801, 803, 805 and 807 feed a positive voltage +M of medium gray level to the corresponding pixel units, while through the data lines DL2, DL6, DL10 and DL14, the source driving ICs 801, 803, 805 and 807 feed a negative voltage −B of ‘black’ gray level to the corresponding pixel units. As the above described, the NOT gate 810 converts the polarity control signal POL into an inversed-polarity control signal/POL. Therefore, the source driving ICs 802, 804, 806 and 808 would, through the data lines DL3, DL7, DL11 and DL15, feed a negative voltage −M of medium gray level to the corresponding pixel units, while the source driving ICs 802, 804, 806 and 808 would, through the data lines DL4, DL8, DL12 and DL16, feed a positive voltage +B of ‘black’ gray level to the corresponding pixel units. Similarly, as the pixel units of the scanning lines SL2˜SL8 are sequentially turned open, the data lines DL1˜DL16 would deliver the corresponding pixel driving signals from the source driving ICs to the turned-on pixel units, respectively.

It can be seen from the above described that, due to the NOT gate, the polarities of the pixel driving signals on a same scanning line and at a same gray level delivered by the data lines DL1˜DL16 are able to complement each other, hence the pixel polarities on any same horizontal scanning line, SL1˜SL8, are neutral to the greatest extent, which can reduce coupling between the common voltage Vcom and the data lines, thereby avoiding crosstalk caused by the coupling and significantly improving display quality.

FIG. 8C is a diagram of a partial pixel unit matrix of the display panel in dot inversion mode of the second embodiment, wherein a frame with a ‘medium gray level’ background color accompanying a central ‘Cs open’ block is shown. Referring to FIGS. 8A and 8C and taking the medium scanning line SL3 as an example, when the pixel units of the scanning line SL3 are turned on, the source driving ICs 801˜808 deliver the pixel driving signals to the turned-on pixel units through the data lines DL1˜DL16. Since the dot inversion mode is used in the display panel, among the pixel units of the scanning line SL3, through the data lines DL1, DL5, DL9 and DL13, the source driving ICs 801, 803, 805 and 807 feed a positive voltage +M of medium gray level to the corresponding pixel units, while through the data lines DL2 and DL14, the source driving ICs feed a negative voltage −M of medium gray level to the corresponding pixel units and through the data lines DL6 and DL10, the source driving ICs feed a negative voltage −B of ‘black’ gray level to the corresponding pixel units. As the above described, the NOT gate 810 converts the polarity control signal POL into an inversed-polarity control signal/POL. Therefore, the source driving ICs 802, 804, 806 and 808 would, through the data lines DL3, DL7, DL11 and DL15, feed a negative voltage −M of medium gray level to the corresponding pixel units, while the source driving ICs would, through the data lines DL8 and DL12, feed a positive voltage +B of ‘black’ gray level to the corresponding pixel units and through the data lines DL4 and DL16 feed a positive voltage +M of medium gray level to the corresponding pixel units. Similarly, as the pixel units of the scanning lines SL2˜SL8 are sequentially turned open, the data lines DL1˜DL16 would deliver the corresponding pixel driving signals from the source driving ICs to the turned-on pixel units, respectively.

In other word, when turning on the pixel units of any same scanning line, each time the polarities of the pixel driving signals at a same gray level delivered by the data lines DL1˜DL16 are able to complement each other, hence the pixel polarities on a same horizontal scanning line of the display panel are neutral to the greatest extent, which can reduce coupling between the common voltage Vcom and the data lines, thereby avoiding crosstalk caused by the coupling and significantly improving display quality.

FIG. 9 is a circuit block diagram of a LCD display panel driving device capable of reducing crosstalk according to the third embodiment of the present invention. Referring to FIG. 8A, the display panel driving device includes a NOT gate 910, a timing controller 920, a LCD display panel 930 and a plurality of source driving unit modules 901˜903. The source driving unit modules 901˜903 can be packaged as a source driving IC, respectively. Each source driving unit module includes a plurality of source driving units. For example, the source driving unit module 901 includes source driving units 901-1˜901−n, wherein each source driving unit drives a corresponding data line of the LCD display panel 930, respectively.

The timing controller 920 sequentially sends a plurality of pixel data A to all source driving units in the source driving unit modules 901˜903 and further outputs a polarity control signal POL. The NOT gate 910 converts the polarity control signal POL into an inversed-polarity control signal/POL. Then, the polarity control signal POL and the inverting-polarity control signal/POL are sent to the polarity ends of partial source driving units and to the polarity ends of rest partial source driving units, respectively.

Taking the source driving unit 901-1 as an example, the source driving unit 901-1 at least includes a latch circuit 901-11 and a digital-to-analog converter (DAC) 901-12. According to a timing provided by the timing controller 920, the latch circuit 901-11 latches the pixel data D. The DAC 901-12 serves for converting the latched pixel data into analog signals. The source driving unit 901-1 outputs pixel driving signals according to the analog signals produced by the DAC 901-12. In addition, the source driving unit 901-1 further decides the polarity of the pixel driving signals according to the signal at the polarity end thereof (the polarity control signal POL herein) and finally drives the pixels of the LCD display panel 930 through the data lines.

In FIG. 9, other source driving units 901-2, 901-3 and 901-4 can have the same structure as 901-1, to receive pixel data A from the timing controller 920 and output the pixel driving signals to the LCD display panel 930. Wherein, the source driving units 901-1 and 901-2 receive a polarity control signal POL, while the source driving units 901-3 and 901-4 receive an inversed-polarity control signal/POL. Therefore, in addition to all data lines having a same structure in dot inversion mode from employing AC driving manner, the polarity of each source driving unit is different from each other, which enables the polarity of each pixel unit to be different from each other. As a result, the polarities of the pixel driving signals at a same gray level delivered by a data line are able to complement each other and the pixel polarities on any same horizontal scanning line of the display panel are neutral to the greatest extent as each scanning line is sequentially turned on, which can reduce coupling between the common voltage Vcom and the data lines, thereby avoiding crosstalk caused by the coupling effect. In this case, where a frame with a ‘medium gray level’ background color accompanying a central ‘Cs open’ block is required, the mechanism is the same as the above-described in FIG. 8C.

From the above described it can be seen that, the timing controller and the NOT gate provide the control signals with different polarities, which are electrical connected to the polarity ends of each source driving unit, such that the source driving units on each horizontal scanning line on the display panel have different polarity distribution. Hence, the positive polarity and the negative polarity on each same horizontal scanning line is able to counteract each other, which significantly reduces crosstalk produced by the common voltage Vcom.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A display panel driving device, capable of reducing crosstalk, the device comprising:
a plurality of source driving ICs, used for outputting a plurality of pixel driving signals to drive the display panel, wherein each of the source driving ICs has a polarity end and decides the polarity of the pixel driving signals to be output according to the polarity end thereof;
a NOT gate, wherein the output end thereof is electrical connected to the polarity ends of the partial source driving ICs, while the input end thereof is electrical connected to the polarity ends of the rest partial source driving ICs; and
a timing controller, used for outputting a plurality of pixel data to the source driving ICs and outputting a polarity control signal to the input end of the NOT gate;
wherein each of the source driving ICs converts the received pixel data into corresponding pixel driving signals for output.

2. The display panel driving device capable of reducing crosstalk as recited in claim 1, wherein the display panel is a LCD display panel.

3. A display panel driving device capable of reducing crosstalk, wherein the display panel has a plurality of data lines, comprising:
a plurality of source driving units, wherein the output end of each source driving unit is electrical connected to one of the data lines of the display panel and is used for outputting a pixel driving signal to drive the display panel; each of the source driving units has a polarity end and decides the polarity of the pixel driving signals to be output according to the polarity end thereof;
a NOT gate, wherein the output end thereof is electrical connected to the polarity ends of the partial source driving units, while the input end thereof is electrical connected to the polarity ends of the remaining source driving units; and
a timing controller, used for outputting a plurality of pixel data to the source driving units and outputting a polarity control signal to the input end of the NOT gate;
wherein each of the source driving units converts the received pixel data into corresponding pixel driving signals for output.

4. The display panel driving device capable of reducing crosstalk as recited in claim 3, wherein the display panel is a LCD display panel.

5. A display panel driving method capable of reducing crosstalk, wherein a plurality of source driving units output a pixel driving signal for driving the display panel, respectively, and each of the source driving units decides the polarity of the pixel driving signal to be output according to the polarity end thereof, respectively; the method comprising:
providing the polarity ends of the partial source driving units with a polarity control signal;
inverting the polarity control signal to obtain an inversed-polarity control signal; and
providing the polarity ends of the rest partial source driving units with the inversed-polarity control signal.

6. The display panel driving method capable of reducing crosstalk as recited in claim 5, wherein the display panel is a LCD display panel.
